(19) United States
(12) Patent Application Publication
(10) Pub. No.: US 2011/0292201 A1
(43) Pub. Date: Dec. 1, 2011

(54) UNDERWATER SCOUTING CAMERA

(76) Inventors: WAYLON WESTPHAL, Hackensack, MN (US); Wade Westphal, Hackensack, MN (US)

(21) Appl. No.: 12/789,212

(22) Filed: May 27, 2010

(51) Int. Cl. H04N 7/18; G01S 15/00

(52) U.S. Cl. 348/81; 367/87; 348/E07.085

(57) ABSTRACT

An underwater scouting camera comprising: an outer cover, a door, a memory storage, a battery, and an internal housing which includes a flash, a shutter, a display frame, and a sonar sensor. When the sonar sensor emits a pulse in order to detect any fish, upon detection the flash and the shutter trigger to take a digital picture that may be saved on a memory device. After the picture is taken, the date and time appear on the display frame, and a notification is transmitted to a personal handheld device. The scouting camera allows a user to remotely track fish without having to continuously monitor the underwater scouting camera.

### BACKGROUND OF THE INVENTION

Fishing is a sporting activity involving hand gathering, spearing, netting, angling and trapping. With the various styles of fishing there are also various techniques used to track the fish. Many fishermen study and familiarize themselves with the type of fish they wish to catch, where the fish may be found and what type of conditions allow for the optimal time to catch the fish. Some fishermen even use high-tech equipment to monitor where the fish are.

Hunting is similar to fishing with the use of high-tech tracking devices. Scouting cameras are well known with hunters to monitor deer, bears and other gaming animals. The scouting cameras may be mounted to a tree or salt lick, and are usually equipped with motion detectors to take pictures of the surrounding area. The cameras stores the pictures on a memory card to be viewed by the hunter once the camera is later retrieved. The scouting camera allows the hunter to learn where the gaming animals frequent to have a better chance of finding them while hunting.

Fishermen also use scouting cameras with a waterproof cover to detect fish in the immediate area to where they are fishing. A problem with these devices is that the motion detectors do not operate well underwater thus the fisherman must continuously monitor the camera.

It would therefore be beneficial to have a scouting camera which may detect fish with another means besides a motion detector. Also, a scouting camera which allows the fisherman to monitor the fish remotely would be highly desired.

### SUMMARY OF THE INVENTION

The present invention provides a means to survey and establish the location and activity of fish at specific times. The underwater scouting camera is a submergible battery operated device that automatically takes a picture of fish when the fish are detected by the sonar sensor. The pictures inform the user of how many fish are in close proximity and at what time. The time and date are recorded and displayed on an input screen, notifying the user of fish trends and behavior.

Another object of the present invention is that the camera can withstand severe temperature and pressure, thus reducing its vulnerability to the elements. Another object of the present invention is that a notification may be sent to a handheld device, including a cellular phone or PDA.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, in which:

FIG. 1 illustrates a perspective view of an open underwater scouting camera, in accordance with an exemplary embodiment of the present invention, and

FIG. 2 illustrates a backside view of the underwater scouting camera in accordance with an exemplary embodiment of the present invention.

Like reference numerals refer to like parts throughout the description of several views of the drawings.

### DETAILED DESCRIPTION

The present invention provides an underwater scouting camera for tracking fish. The underwater scouting camera may be mounted to the bottom of a boat or submerged in a watering hole to detect the fish. While other scouting cameras are presently used in the art, there are none currently available which incorporate the unique features of the present invention.

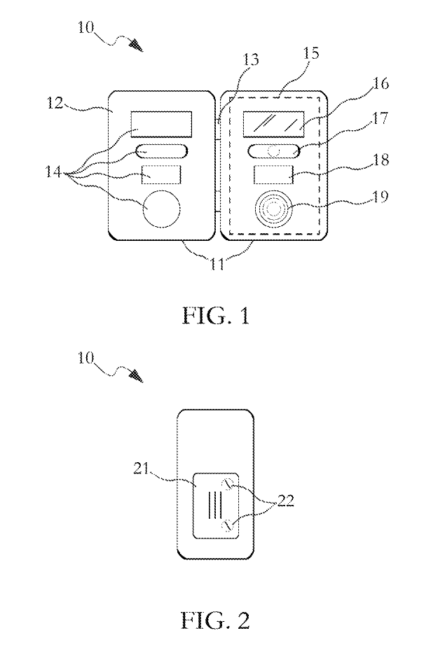

Turning descriptively to the drawings, FIG. 1 illustrates an opened underwater scouting camera (10) in accordance with the preferred embodiment of the present invention. The underwater scouting camera (10) may have an outer cover (11) which may contain a door (12) which opens on a hinge (13) to expose an internal workings housing (15). The outer cover (11) may protect the internal workings housing (15) from external elements like water, severe temperatures and pressure or destructive physical contact. The outer cover (11) may be made of a hard plastic, or another comparable material, for durability, lightweight and economic considerations. The internal workings housing (15) may comprise a flash (16), a shutter (17), a display frame (18) and a sonar sensor (19). The flash (16) and the shutter (17) may operate similar to those on a conventional digital camera. The display window (18) may show the date and time that a digital picture was taken. The digital pictures may be stored on an internal memory device such as a memory card or storage unit so that the pictures may be viewed at a later time. The door (12) may have a plurality of windows (14) covering the flash (16), the shutter (17), the display frame (18) and the sonar sensor (19). The window (14) over the display frame (18) may allow a user to view information when the door (12) is closed. The windows (14) covering the flash (16), the shutter (17) and the sonar sensor (19) allow these features to serve their function without being blocked when the door (12) is in a closed position. The outer cover (11) may have a coloring that will camouflage the underwater scouting camera (10) from a fish when submerged under water. For example the outer cover (11) may be blue, gray or even white if mounted to the bottom of a boat.

The sonar sensor (19) may emit a pulse into the open water. If there is a fish, or another aquatic animal, near the underwater scouting camera (10) the pulse bounces off of the body of the fish and the vibrations may be detected by the sonar sensor (19). Once the sonar sensor (19) detects that any fish are in a proximate area, it will trigger the underwater scouting camera (10) take a picture of the proximate area. The date and time the picture is taken may be recorded and stored in the memory device of the underwater scouting camera (10) to be later displayed in the display frame (18). A unique feature of the present invention is that the pulse may be emitted at timed periodic intervals, and only when a fish is present will the underwater scouting camera (10) take a picture. Since the pulse is periodic, then the user does not have to continuously monitor the present invention. The user may be in a remote location, removed from the underwater scouting camera (10).

The underwater scouting camera (10) may have an internal transmitter which may send a notification via an electronic signal to a personal handheld device, such as a cell phone, PDA or other device capable of receiving such transmissions, when a picture is taken. Similarly, the pictures may be transmitted to an online server which may upload the pictures to a designated website. Thus, the user may be alerted remotely of when fish are in the area of the underwater scouting camera (10), how often they are present and which types of fish frequent the area. The user may study the pictures remotely to determine the best times to catch fish. Referring to FIG. 2, a backside view of the underwater scouting camera according to an exemplary embodiment of the present invention is shown. The underwater scouting device (10) may have a battery compartment cover (21) which may be secured in place with screws (22). The screws (22) may tightly fasten the battery compartment cover (21) to create an airtight and waterproof seal. The battery compartment cover (21) may protect a battery which provides power for the scouting device (10). The battery may be an alkaline, lithium or other suitable battery composition so that the underwater scouting camera may be used without an external power source. A low battery LED light (not shown) may be provided on the scouting device (10) that provides a means to indicate when the battery power is running low.

The battery power source, coupled with the sonar sensor and memory storage may enable the underwater scouting camera (10) to function independently of the user thereof. The user may mount the underwater scouting camera under a boat or in a fishing hole and leave it alone. While the user is remote from the camera, the underwater scouting camera will monitor the proximate area around it by using the sonar sound pulses and camera features to photograph pictures of the surrounding fish. Since the present invention is battery powered, the user may leave the camera unattended for a significant period of time. Once a collection of pictures are taken, the user may then study them and determine optimal fishing times.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An underwater scouting camera comprising:
an outer cover;
a door;
a memory storage;
a battery; and
an internal workings housing which comprises a flash, a shutter, a display frame, and a sonar sensor, wherein when the sonar sensor emits a pulse and detects a fish, the flash and the shutter trigger to take a digital picture which saves on the memory storage.

2. The underwater scouting camera according to claim 1, wherein the sonar sensor emits the pulse at a periodic interval.

3. The underwater scouting camera according to claim 1, wherein the door has a plurality of windows to allow the display frame to be viewed when the door is closed and for the flash, the shutter and the sonar sensor to detect and take the digital picture of the fish.

4. The underwater scouting camera according to claim 1, wherein the display frame shows a date and time recorded when the digital picture is taken.

5. The underwater scouting camera according to claim 1, wherein the digital picture is sent by an internal transmitter to a server and uploaded to a website.

6. The underwater scouting camera according to claim 5, wherein the internal transmitter sends an electronic signal to a personal handheld device when the digital picture is taken.

7. The underwater scouting camera according to claim 1, wherein the outer cover protects the internal workings housing, the memory storage and the battery from a plurality of external elements.

8. The underwater scouting camera according to claim 7, wherein the external elements are water, severe temperature and pressure or damaging physical contact.
